(19) United States
(12) Patent Application Publication
(10) Pub. No.: US 2014/0096867 A1
(43) Pub. Date: Apr. 10, 2014

(54) Balloon Inflation, Illumination and Holding Device

(71) Applicant: Paul E. Cayton, New York, NY (US)

(72) Inventor: Paul E. Cayton, New York, NY (US)

(21) Appl. No.: 13/762,051

(22) Filed: Feb. 7, 2013

Related U.S. Application Data
(60) Provisional application No. 61/795,059, filed on Oct. 9, 2012.

(51) Int. Cl. B67C 11/06

(52) U.S. Cl. CPC B67C 11/06
USPC 141/98

(57) ABSTRACT

A device for inflating, illuminating and holding a balloon like a torch, or attaching the illuminated balloon in an upright fashion to an ornamental base, without the use of helium. The device includes illumination means, a power, supply and related circuitry, a pathway for inflating and sealing the balloon, and an elongate handle. The device further includes a switch with a trigger mechanism positioned outside of the region where the balloon is attached, so that the illumination means or lighting mode can be easily controlled by the user, including a child. The device is also configured to be safely used without a balloon, as a decorative light or a flashlight, or as a holding device for a balloon without any illumination means.

### RELATED APPLICATION

This application claims priority from Provisional Application Ser. No. 61/795,059 filed Oct. 9, 2012, the content of which is incorporated herein in its entirety.

### BACKGROUND OF THE INVENTION

The present invention relates to a low cost, light weight device for securing, inflating, illuminating and holding a balloon.

Balloons inflated with air and with helium have been used as decorations for celebrations for many years. The decorative effect has been enhanced by the use of shaped balloons and balloons made out of materials such as mylar. Once inflated the balloon opening can be sealed by tying with a ribbon or string, or through use of a closure that seals the balloon opening and allows the balloon to be attached to a string, lanyard or stick. Helium is typically used as the inflation gas, if the user desires to position the balloon upright.

Internally illuminated balloons are attractive, and have been used as novelty items. Some have tried to illuminate balloons from the interior, via a lamp positioned inside the balloon. For example, U.S. Pat. No. 5,947,581 discloses a balloon illumination device wherein an illumination member and power source may be positioned within the gas storage region of a balloon. Unfortunately, such designs have significant disadvantages, including because the batteries cannot be replaced and because they are not reusable. This patent also discloses an embodiment wherein the light source is attached to the exterior wall of the balloon. However, such design also has limitations in that the device must be adhered to the flexible balloon material, and the weight associated with the device may cause the balloon to be unbalanced.

For internally illuminated balloons, some have used a mechanical fastener that attaches to the neck of a balloon and which positions a lamp or bulb inside the neck of the balloon. One such device is described in U.S. Pat. No. 7,571,875. With such a device, the balloon neck is positioned over and onto a horn structure of the fastener, which causes the balloon to be sealed to prevent deflation. Thereafter, the balloon may be inflated, and decorative ribbons or tubes can be attached to the balloon neck or the structure of the fastener, for tethering purposes. Other similar devices require the balloon to be inflated prior to attachment. However, such devices include certain limitations which make them difficult to operate. For example, the device positions the balloon over the switch and battery compartment, so as to seal them from air leakage. As a consequence, it is difficult for a person, especially a child, to manipulate the switch. Further, such devices cannot be used without a balloon, because the lamp switch mechanism is activated by placement of the balloon over the horn. These devices also do not incorporate a handle that permits the user to carry the balloon upright like a torch, or to position the balloon upright on a base such that it to be used as a stationary decorative item.

### SUMMARY OF THE INVENTION

The present invention provides a device and method for inflating, sealing and lighting a balloon, and positioning the inflated, lighted and sealed balloon on a handle or base so that it can be carried upright like a torch or used as an ornamental item, without the use of helium. The invention includes a tubular assembly containing a light, such as one or more light emitting diodes (LEDs), circuitry for control of the light, an accessible power supply compartment containing a battery, and a switch which enables the user to turn the light on and off and select the desired lighting function provided by the circuitry. The assembly is designed so that a portion can be inserted into the neck of the balloon, to connect to the assembly to the balloon and provide for internal illumination of the balloon without causing the balloon to cover the battery compartment or switch.

The tubular assembly of the present invention also includes a valve mechanism, which permits the balloon to be inflated after attachment to the assembly, such that air or another non-helium gas may enter into and fill the balloon, but not exit the assembly.

The tubular assembly provides a partial enclosure for the light and related electronic components of the device, which helps protect them from damage, and serves to detachably connect the light to the neck of the balloon. The assembly comprises a material and shape that allows light emitted by the light source to shine up through the assembly and into the balloon, and provide for even illumination of the balloon. Although depicted herein as a cylinder, the assembly can be made in other shapes without departing from the spirit or scope of the invention. Because the light source is positioned partially or completely within the assembly, and the neck of the balloon is positioned around the outside of the assembly, the balloon material does not come into contact with the light source, resulting in a safer device than prior designs.

The switch for the light source is positioned on or in the tubular assembly, with a trigger mechanism positioned at a location that will be external to the balloon neck when the device is attached to a balloon, so that it may be activated any time by the user to cause the light to operate. Thus, the light can be activated and the assembly used as a flashlight or a decorative light or toy, with or without a balloon. If used with a balloon positioned on the assembly, the switch can be activated after inflation. The switch can be turned on or off while a balloon is attached, or activated multiple times to change the function of the light.

The tubular assembly is designed to securely attach to a handle, so that the lighted balloon may be carried upright by a user, such as a child, without requiring the use of helium. In the alternative, the assembly may be formed as an integral part of the handle. The tubular assembly and handle may also be attached to other types of objects and bases, so that the lighted balloon may be used as a decorative ornament positioned, for example, on a tabletop.

It is an object of the invention to provide a compact device for securing, inflating, and illuminating a balloon, which includes a handle that enables a person to hold the balloon upright. It is also an object of the invention to provide a compact device for securing, inflating and holding a balloon upright on a handle, without providing for illumination.

It is a further object of the invention to provide such a device which can be produced economically at high volume by conventional mass production techniques.

It is a further object to provide such device that includes a removable and replaceable battery, or a rechargeable battery, such that the device may be re-used, with different balloons.

It is also an object of the invention to provide a device wherein the balloon and tubular assembly may be removed from the handle, such that the device could be attached to a different handle, or attached to an alternative base. The handle can be ornamental in its appearance, of fixed or adjustable length, of different shapes and sizes including shaped like a toy object, or designed to incorporate other goods such as toys or candy.

It is a further object of the invention to provide a device for securing, inflating and illuminating a balloon wherein the illumination switch is positioned external to the portion of the device attached to the balloon, such that said switch can be easily actuated and manipulated, including by a child.

It is a further object of the invention to provide a balloon with a light source that can illuminate a balloon with different colors, and provide a variety of lighting effects, such as flashing lights, changing colors, and changing light patterns.

Unlike prior balloon illuminating devices having internal lighting and internal power sources, use of the contemplated device is not restricted to any particular type of balloon and is not permanently attached to the balloon. Instead, the device is releasable and can be removed from one balloon and used to inflate or illuminate another balloon, as desired.

### BRIEF DESCRIPTION OF THE DRAWINGS

In order that the invention may be readily understood, specific embodiments thereof will now be described by way of example only and with reference to the accompanying drawings in which:

FIG. 1 is a perspective view showing an inflated balloon light in accordance with one preferred embodiment of the invention.

FIG. 2 is an exploded view of the device shown in FIG. 1.

FIG. 3 is a cross sectional view of the tubular assembly of the balloon light shown in FIG. 1.

FIG. 4 is a perspective view of a base in accordance with an embodiment of the invention.

FIG. 5 is another view of a base in accordance with an embodiment of the present invention.

FIG. 6 is a view of an alternative tubular assembly and light in accordance with an embodiment of the present invention.

FIG. 7 shows an alternate handle design in accordance with an embodiment of the invention.

### DETAILED DESCRIPTION OF THE INVENTION

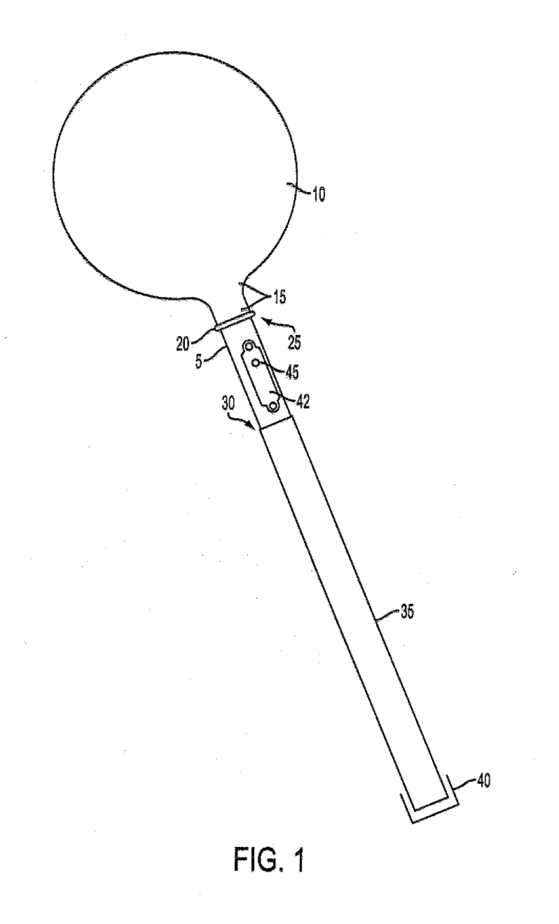

One mode for carrying out the invention is herein described in connection with FIGS. 1-7. However, the invention is not limited to the described embodiment and a person skilled in the art will appreciate that many other embodiments of the invention are possible without deviating from the basic concept of the invention, and that any such work around will also fall under scope of this invention. It is envisioned that other styles and configurations of the present invention can be easily incorporated into the teachings of the present invention, and only one particular configuration shall be shown and described for purposes of clarity and disclosure and not by way of limitation of scope.

Headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). The terms “a” and “an” herein do not denote a limitation of quantity, but rather denote the presence of at least one of the referenced items.

The present invention advantageously provides a device and method for sealing, inflating, illuminating and holding a balloon. The device, when inserted into the neck of the balloon, creates an airtight seal between the device and the balloon. This enables the balloon to be inflated after assembly. The balloon may be inflated repeatedly as needed without removing the device. The device may also be detached from the balloon, and attached to a different balloon, enabling the device to be reused.

The device includes multiple elements, such as the balloon, an assembly including the light and associated electronics, and a handle. The tubular assembly connects to the balloon and handle, and contains a light, the light circuitry, a power source, a valve, and a passageway for air to flow into the balloon. The light is positioned within the upper opening of the tubular assembly that is to be attached to the neck of the balloon. When assembled and attached to a balloon, the light positioned within the tubular assembly shines into the balloon, and where it is disseminated within the balloon to provide even illumination. If desired, the device can also be manufactured without a light, in which case it would serve as a mechanism for inflating and holding a balloon.

The light may be a LED light, containing one or more LEDs. For example, the light may consist of three different colored LEDs, so as to provide a light source capable of providing multiple colors. The light circuitry may provide for selection of a single color, a series of sequentially changing colors, a specific light pattern, such as a flashing pattern, a series of changing patterns, or a combination of any of the foregoing. The light is controlled by a switch means, which is activated in response to the pressing of a button positioned external to the tubular assembly, so that the user may control when the light is on or off, and may select from different lighting functions provided by the light circuitry. The button is positioned so that it is not covered by the balloon neck, which enables the user, including a child, to readily manipulate the selector switch to control the function of the light. Other switch mechanisms and activation means may be employed without departing from the spirit and scope of the invention.

The tubular assembly also includes a valve to allow the balloon to be inflated after it is attached. The valve operates in conjunction with an air pathway within the housing of the device, to permit the balloon to be inflated after it is attached to the tubular assembly. The valve prevents air from exiting the balloon. The balloon may be inflated by blowing air through the tubular assembly, before it is attached to the handle. In the alternative, the balloon may be inflated after the tubular assembly is attached to the handle, by blowing air through the handle. The handle may also include a cover, which helps minimize any air leakage.

The complete device is low in weight, such that it is easy for a child to hold and carry the balloon via the handle. The device may also be designed so that it can float when a balloon of suitable size is filled. When the balloon is attached and inflated, the balloon remains attached to the tubular assembly.

The present invention will now be described more fully hereinafter with reference to the accompanying drawings, in which preferred embodiments of the invention are shown. This invention may, however, be embodied in many different forms and should not be construed as limited to the illustrated embodiments set forth herein. Rather, these illustrated embodiments are provided so that this disclosure will be thorough and complete, and will fully convey the scope of the invention to those skilled in the art.

As shown in FIG. 1, the invention includes a tubular assembly 5 for connection to a balloon 10, such as a common latex balloon, having a cylindrical balloon neck 15, with a ring 20 at the opening. The tubular assembly 5 includes an upper end 25 and a lower end 30. The lower end 30 of the tubular assembly may be attached to a handle 35, which is shown as a hollow cylinder, although other shapes can be utilized. The handle can include a cap 40 to seal its open end. The upper end of the tubular assembly includes a lip 78. The tubular assembly includes a battery compartment 42 which is accessible from the exterior of the tubular assembly. The tubular assembly 5 also includes a switch or switch button 45 for controlling a light source.

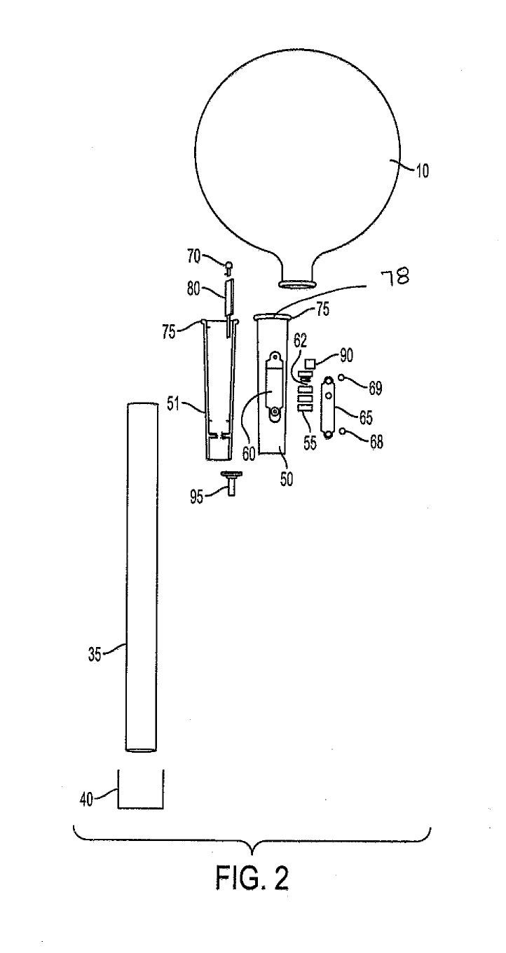

As shown in FIG. 2, the tubular assembly 5 can be made of two components, for example, an upper housing 50 and a lower housing 51. Either housing may include a compartment 60 for the power source, such as one or more batteries 55. Here, the compartment 60 is shown in upper housing 50. The batteries may be held in position via a spring, 62. The compartment 60 includes a removable access panel 65, which enables the batteries to be accessed and replaced. The removable access panel may be secured with screws 68, 69.

The tubular housing 5 preferably includes a light source 70 positioned in the opening of the upper end 75. The light source 70 may be any suitable light, such as an LED or a series of LEDs. The light may be configured to provide light in one or more colors, or a series of changing colors. The light source may also be configured to provide a pattern of lights, such as a flashing or blinking light, or series of patterns. Alternatively, the light can provide a series of colors and patterns or a combination of attributes. The light could be configured to provide a pattern or an image, which could be displayed on the inside of the balloon or displayed on the floor or ground if the device is used without a balloon.

The light source 70 is attached to electronic circuitry 80 which controls the light source. The circuitry can be a printed circuit board, an integrated circuit board, an asic, or more advanced electronics such as a programmable microprocessor. The circuitry is connected to the power source. A switch (not shown) to control the circuitry is electrically connected to the power source and the circuitry. Those skilled in the art will realize that the circuitry may include any one of a number of known circuits which provide functions related to controlling power flow to the light source. Depending on the design of the electronic components, or if multi-bulb or multi-LED or a multifunction light is to be provided, the switch may be configured to act as an on-off switch, a mode selector switch, or a combination thereof. For example, in communication with the integrated circuit, the switch may set the flash rate, color, or brightness of the light source. The switch may be configured to close the circuit, connect the power source to the light source and to select the desired mode or function. Alternatively, the device could include a separate on-off mechanism, and the switch could be configured as a mode selector switch to select the desired light function. The switch can be activated via a button press, by sliding an actuator, by direct contact with the user's finger, or via other mechanisms well known in the electronics arts. In FIG. 2, the switch is triggered via button 90.

The switch may be operated independently of whether a balloon is attached to the device, enabling the tubular assembly to be used, attached to or independent of the handle, as a flashlight, as a decorative light, or as a novelty light, with or without a balloon. The circuitry could also be activated or controlled by motion via a motion sensor, to provide additional lighting effects.

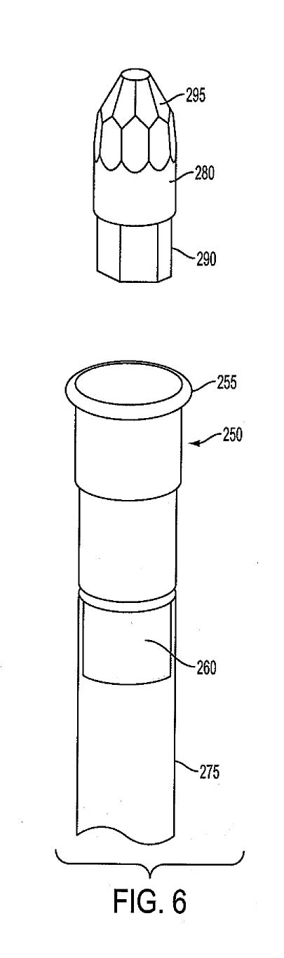

The tubular assembly 5 encloses and protects the electrical components, including the light 70 and power source 55, and may be shaped in a configuration for directing or dispersing light emitted from the light source into the interior of the balloon 10. The tubular assembly may also be of a shape that is non-cylindrical. In an alternative embodiment, the housing may include a clear cover over the opening to protect the light source while allowing inflation air and light from the light source to pass through. FIG. 6 depicts a further alternative embodiment, in which the light and electronics are contained within a separate clear housing 280 that is removably positioned within the upper opening 255 of the tubular assembly 250. In this figure, the housing has a lower end 290 that is inserted into the opening of the tubular assembly 255. The lower end of the tubular assembly 260 is removably inserted or otherwise attached to the handle 275. These alternative embodiments are useful where it is desired to enable use of the device without a balloon. Further, the cover over the light source or the housing 280 may include a pattern or design 295, so as to permit the pattern to be displayed within the balloon, or on the ground when used as a flashlight or novelty light.

Referring back to FIGS. 1-3, the tubular assembly also includes a raised lip 78 around the top opening 75. In use, the neck of the balloon is placed over this lip, which helps ensure a secure connection between the balloon 10, balloon neck 15, balloon ring 20 and the tubular assembly 5. When assembled, the compartment and the switch button 45, 90 are not covered by the neck of the balloon so as to permit easy control of the light, and access to the compartment, if needed. Since balloons are available in a variety of different sizes, the tubular assembly may be made in various dimensions to accommodate different size balloons, and advanced circuitry.

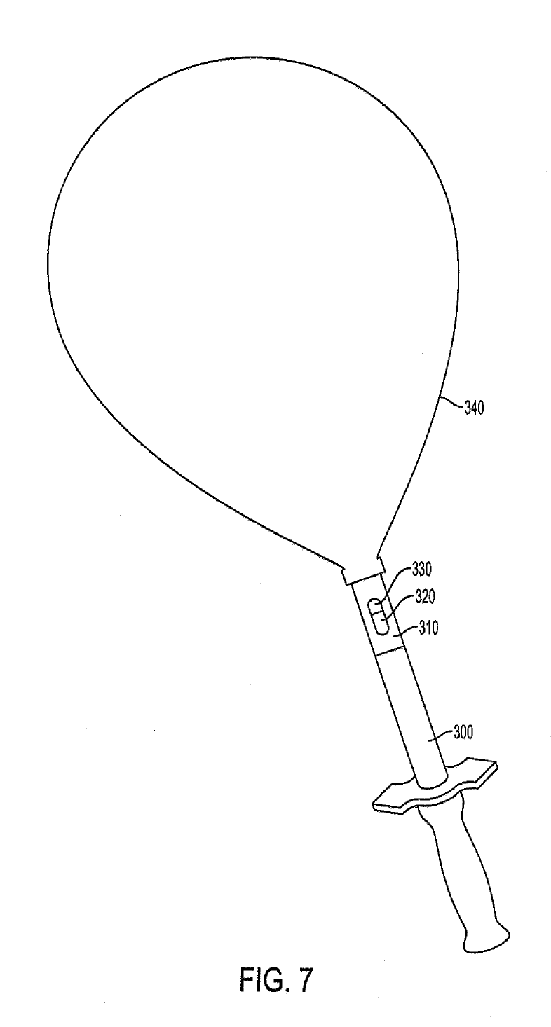

The handle 35 is designed to be securely attached to the lower end of the tubular assembly 5. The handle may be provided in a single length, in different size lengths, or in a length that is adjustable by the user, such as a series of segments nested together. The handle can be manufactured to match the diameter or cross-section of the tubular assembly 5. In the alternative, the handle 35 may be made available in a single diameter or cross-section, and the tubular assembly could be manufactured to have a lower diameter or cross-section that matches the shape and size of the handle. The handle can be made in various shapes, colors and decorative or functional configurations, including holiday themed designs and play objects or toys, for example a sword, a baseball bat, a candy cane and the like. FIG. 7 depicts the handle in the shape of a sword. In this embodiment, the sword-shaped handle 300 is attached to tubular assembly 310. The tubular assembly includes compartment 320, and switch actuator 330. The tubular assembly is connected to balloon 340. For added utility, the handle may be designed to hold additional objects, such as toys or candy. The tubular assembly can also be manufactured as an integral part of the handle, rather than a separate component.

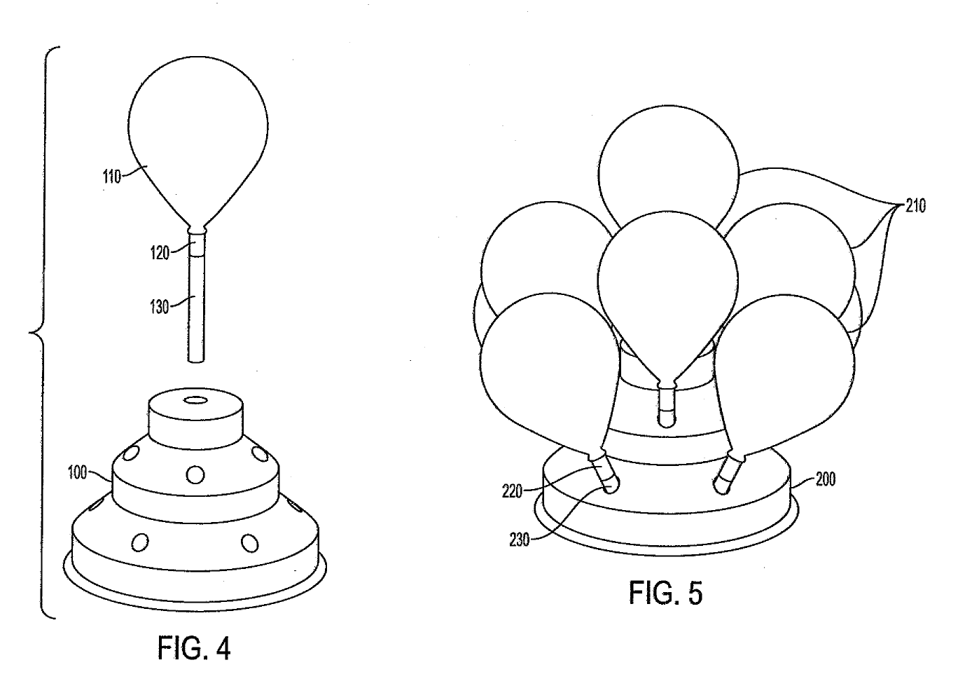

As shown in FIGS. 4-5, the tubular assembly 5 and handle can be designed to fit into a base, which enables illuminated balloons to be positioned as non-mobile decorative items, such as on a table top. In such embodiment, different length handles can be attached to the base, such that balloons of different heights can be decratively positioned together.

As shown in these figures, base 100, 200 should be of sufficient weight and size to retain the number of balloons it is designed to retain. Balloons 110, 210 are positioned on tubular assemblies, 120, 220 and handles 130, 230. After inflation, the handles are inserted into the base, which retains them in a decorative fashion. Such configuration could also be used as a holder for dispensing balloons to people at an event.

The tubular assembly 5 includes one or more flow paths therein for permitting air to flow therethrough to inflate the balloon. To inflate a balloon, the user can blow air through opening at the lower end 30 of the tubular assembly 5. This air will flow through the flow path, through the upper end 25 of the tubular assembly 5 and into the balloon 10. The flow path is isolated from the power source and the switch, so that air cannot flow out through the switch opening or the battery compartment. Alternately, when handle 40 is attached to the tubular assembly, or where the assembly and handle are formed as one integral component, the balloon may be inflated by blowing air through the opening in the handle, which acts as a mouthpiece. After the balloon is inflated, a cover 40 may be placed over the opening of the handle.

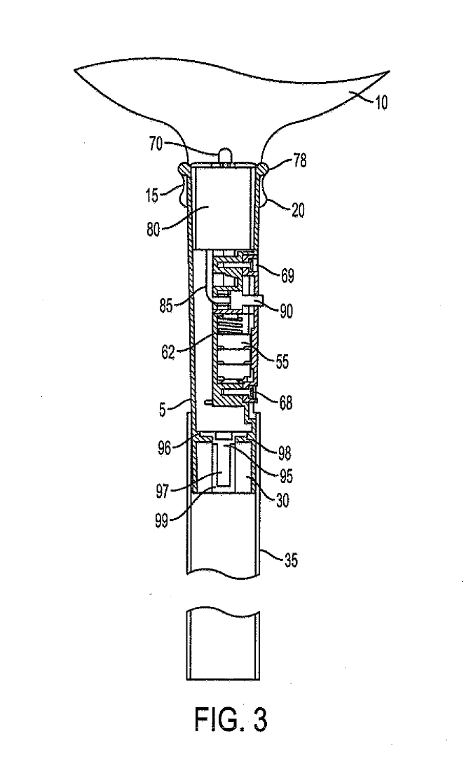

As shown in FIG. 3, a valve 95 positioned in tubular assembly acts to seal the air in the balloon and the pathway through the tubular assembly. Although any suitable valve configuration may be used, the preferred valve 95 is a t-shaped valve that includes a disc 96 and a stem 97. The disc 96 fits around the circumference of the tubular assembly and is seated against sealing flange 98, while the stem 97 is positioned within stem hole 99. During inflation, the valve is displaced from the sealing flange 98, permitting air to flow towards and into the balloon. When inflation stops, air pressure in the balloon and pathway pushes against the disc 96 to seal it against the sealing flange 98, preventing air from escaping through the bottom of the housing. The stem 97 ensures that the disc 96 remains in correct position against or away from the sealing flange 98. A cover 40 may also be added to the end of the handle, to help prevent the escape of air from the device.

For added decorative effects, the tubular assembly or the handle may be formed from, or include, materials that luminesce in response to light of a certain wavelength, such as UV light, or in response to a chemical reaction. In an alternative embodiment, the balloon may be formed from, or include, a material that luminesces in response to UV light. The handle could also incorporate materials that glow in the dark.

As show in FIGS. 2 and 3, to assemble the device, the bulb/LED and electronics are positioned within the upper end 25 of the tubular assembly 5. The batteries 55 are positioned in compartment 60 and held in place with the spring 62. The battery access panel 65 is closed. The switch and switch actuator 90 are attached between the battery compartment and the electronics, or adjacent the electronics. The valve 95 is positioned in tubular assembly, towards the lower end. The lower and upper housing members 50, 51 of the tubular assembly are then attached to each other.

To attach the handle, the tubular assembly 5 is inserted into handle 35. The handle may be secured by any suitable mechanical means, including, for example, press-fitting, threading, or a bayonet-type mount. If necessary, a sealing mechanism, such as an o-ring or other gasket, may be incorporated into this connection. In the alternative, the tubular assembly may be formed as an integral part of the handle.

To use the device, the neck 15 of a balloon 10 is stretched tightly over the tubular assembly 5 until the ring of the balloon 20 fits over the upper lip 78 of the tubular assembly. Thereafter, the balloon may be inflated by a person blowing through the opening in the lower end of the assembly. Alternatively, the user may attach the handle, remove the cap 40 from the handle, and inflate the balloon by blowing through the open end of the handle. After the balloon is inflated, the user may place the cap back onto the open end of the housing to safeguard against balloon deflation.

When the balloon is inflated with air or a non-helium gas, the tubular assembly and handle enable the user to hold the balloon upright without the use of helium, thereby avoiding the cost associated with helium. The balloon may also be made of an inelastic material, as is well known, but this may require the use of additional means, such as string or a rubber band, to adhere and seal the balloon against the tubular assembly.

What is claimed is:

1. An apparatus for inflating, illuminating and carrying a balloon comprising:
an assembly having upper and lower ends, wherein said upper end is configured to fit within and attach to a neck of a balloon;
a light source mounted in the upper end of the assembly to illuminate the inside of the balloon;
a power source disposed in the assembly providing power for the light source;
a light control circuit mounted within the assembly which provides for control of the light source;
a switch mechanism positioned in the assembly and which may be actuated outside the assembly, said switch mechanism operable to connect the power source to the light source and to enable the user to select a lighting mode from the light control circuit;
a handle for releasable attachment to the lower end of the assembly;
a flow path within the assembly, which permits air to be blown through the assembly and into the balloon; and
a valve mechanism for sealing the flow path after inflation of the balloon, whereby inflation of the balloon is achieved using air.

2. The apparatus of claim 1, wherein the switch mechanism is actuated via a button positioned through the wall of the assembly outside the upper end attached to the balloon.

3. The apparatus of claim 1, wherein the light source comprises an LED and the light control circuit comprises an integrated electrical circuit configured to provide at least one of the following light modes: single color, multi-color, sequential multi-color, single color flashing, multi-color flashing, sequential color flashing.

4. The apparatus of claim 1, wherein the handle enables a user to carry the balloon.

5. The apparatus of claim 4, further comprising a cap for releasably sealing the open end of the handle when the handle is attached to the assembly.

6. The apparatus of claim 4, wherein the handle is configured as a child's toy.

7. The apparatus of claim 4, wherein the handle is configured with a holiday theme.

8. The apparatus of claim 1, further comprising a rigid base for receiving and holding a balloon and handle, which enables the balloon to be positioned as a decorative arrangement.

9. The apparatus of claim 8, wherein the base is configured to retain a plurality of balloons and handle assemblies.

10. The apparatus of claim 1, further comprising a recess formed in surface of the assembly for housing the power source and providing access thereto.

11. A non-helium inflated balloon illumination and carrying device comprising:
a housing having an inlet and an outlet for sealing insertion into a neck of a balloon positioned around the outlet;
a flow path within the housing for conducting an inflation gas other than helium from the inlet to the outlet of the housing;
a flow control system disposed in the flow path allowing the inflation gas to flow from the inlet to the outlet;
a light source mounted in conjunction with the housing;
a power source disposed within the housing providing power for the light source;
a switch mounted in conjunction with the housing and operable to selectively connect the power source to the light source by completing a circuit between the power source and the light source;
a switch activating member positioned through the wall of the housing to operate the switch; and
a handle attached to the housing for holding an attached inflated balloon upright.

12. The device of claim 11, wherein the light source provides for multiple lighting effects selectable via the switch activating member.

13. The apparatus of claim 12, wherein the lighting effects comprise single color, multi-color, multi-color sequential and flashing.

14. The apparatus of claim 11, wherein the flow control system comprises a valve operatively associated with a portion of the flow path.

15. The apparatus of claim 14, wherein the valve means comprises an annular sealing member coaxial with the length of the housing.

16. The apparatus of claim 11, wherein the handle is configured as a child's toy.

17. The apparatus of claim 11, wherein the handle is configured with a holiday theme.

18. The apparatus of claim 11 further comprising a base for holding one or more inflated balloon and handle assemblies in an upright manner.

19. The apparatus of claim 11 wherein the non-helium inflation gas is air.

20. A method for carrying a non-helium inflated, illuminated balloon upright comprising:
providing an assembly having upper and lower ends with a light source mounted in the upper end, a power source for providing power for the light source, a light control circuit that provides for control of the light, and a switch actuatable outside the assembly to connect the power source to the light source and enable the user to select a lighting mode from the light control circuit;
a handle attached to the lower end of the assembly, said handle providing a flow path for the air or non-helium gas through the handle to the upper end of the assembly, said flow path being sealable with a one-way valve mechanism positioned therein;
positioning a balloon on the upper end of the assembly;
inflating the balloon by blowing air or a non-helium gas through the path thereby sealing said air or non-helium gas in said balloon by closing said one-way valve mechanism; and
enabling a user to hold the balloon in an upright position without the use of helium by grasping the handle.
